(19) United States
(12) Patent Application Publication
(10) Pub. No.: US 2024/0080372 A1
(43) Pub. Date: Mar. 7, 2024

(54) SYSTEMS AND METHODS FOR REMOTE DEVICE MONITORING

(71) Applicant: BL Technologies, Inc., Minnetonka, MN (US)

(72) Inventors: Craig Bennett, Hollywood Birmingham (GB); Andrew Leach, Warrington, PA (US)

(21) Appl. No.: 18/270,596

(22) PCT Filed: Dec. 21, 2021
(86) PCT No.: PCT/US2021/064498

§ 371 Date: Jul. 7, 2023

Related U.S. Application Data
(60) Provisional application No. 63/132,853, filed on Dec. 31, 2020.

(51) Int. Cl. H04L 67/565; H04L 12/40; H04L 67/10

(52) U.S. Cl. CPC H04L 67/565; H04L 12/40; H04L 67/10; H04L 2012/40215

(57) ABSTRACT

A wireless gateway is provided that is adapted to receive output data from a variety of connected devices such as pumps from a variety of different manufacturers. The gateway connects to each pump associated with an end user using a wired or wireless connection. The gateway receives output data from a pump in a first format that is specific to the type of pump or the manufacturer of the pump. The gateway then converts the output data into a second format based on knowledge about the type or manufacturer of the pump. The gateway then provides output data in the second format to a platform accessible by a service provider and the end user. The output data may be provided through a wired or wireless connection (e.g., cellular connection) between the gateway and a cloud-based platform used by the end user.

### CROSS-REFERENCE TO RELATED APPLICATIONS

This application claims priority to U.S. Provisional Patent Application Ser. No. 63/132,853, entitled “SYSTEMS AND METHODS FOR REMOTE DEVICE MONITORING”, and filed on Dec. 31, 2020. The disclosure of which is hereby incorporated in its entirety.

### BACKGROUND

Pumps, and other devices, have an internal protocol that is used to output events and other data related to the functioning of the pumps. Generally, the pumps output the data using the protocol through a local interface. As a result, in the event of a malfunction or other issue rated to the pump, a technician must be dispatched to the pump location to interface with the pump and read the data.

As a solution to the problem, many pump manufacturers have developed solutions, such as wireless adaptors, that receive output data from associated pumps and wirelessly provide the data to a cloud service associated with the manufacturer. The end user may then use the cloud service to view the data associated with their pump.

However, there are drawbacks associated with this solution. First, an end user may desire to incorporate the data output by their pumps with the data output by other sensors associated with the end user. Depending on the solution provided by a pump manufacturer, it may be cumbersome or impossible to export the pump data to another application for analysis. Second, where an end user uses pumps from multiple manufacturers, the end user may be forced to use multiple independent cloud services to view the data from all of their pumps. Third, each pump manufacturer may require its own proprietary gateway to be installed at a user location to receive data from its pumps. This forces the end user to pay for and maintain multiple devices and adds additional points of failure into the systems.

### SUMMARY

A wireless gateway is provided that is adapted to receive output data from a variety of connected devices such as pumps, from a variety of different manufacturers. The gateway connects to each pump associated with an end user using a wired or wireless connection. The gateway receives output data from a pump in a first format that is specific to the type of pump or the manufacturer of the pump. The gateway then converts the output data into a second format based on knowledge about the type or manufacturer of the pump. The gateway then provides output data in the second format to a platform accessible by a service provider and the end user. The output data may be provided through a wired or wireless connection (e.g., cellular connection) between the gateway and a cloud-based platform used by the end user. Once received, the platform may allow the end user to view the data output by all of their pumps, sensors, and other devices in a common application or interface regardless of the manufacturers of the pumps, sensors, or other devices. In some embodiments, the end user may also provide commands to the pumps through the interface. The gateway receives the commands and translates the commands into the first language that is understood by the pumps.

In an embodiment, a method for interfacing multiples devices with a platform using a gateway is provided. The method includes: receiving first data from a first device by a gateway, wherein the first data is in a first format; receiving second data from a second device by the gateway, wherein the second data is in a second format; converting the first data into a third format associated with a platform by the gateway; converting the second data into the third format associated with the platform by the gateway; and providing converted first and second data to the platform by the gateway.

Embodiments may include some or all of the following features. The method may further include presenting the converted first and second data to a user by the platform. The method may further include presenting data received from one or more other devices along with the converted first and second data to the user by the platform. The first device may be a pump. The first format may be the CAN-BUS protocol or the MOD-BUS protocol. The third format may be the XBEEE, Wi-Fi, or similar format. Converting the first data into the third format associated with the platform by the gateway device may include retrieving a script associated with the first device and converting the first data into the third format using the script.

In an embodiment, a gateway for interfacing multiple devices with a platform is provided. The system includes at least one computing device; and a memory storing computer-executable instructions that when executed by the at least one computing device cause the at least one computing device to: receive first data from a location interface of a pump, wherein the first data is in a first format and the first data describes operating characteristics of the pump; retrieve a script associated with the pump; convert the first data into a second format using the script; and provide the converted second data to a platform.

Embodiment may include some or all of the following features. The computer-executable instructions may further include computer-executable instructions that when executed by the at least one computing device cause the at least one computing device to: receive second data from a plurality of devices; and display at least some of the first data and the second data in a graphic user interface. The computer-executable instructions may further include computer-executable instructions that when executed by the at least one computing device cause the at least one computing device to: receive second data from the platform, wherein the second data is in the second format, wherein the second data is an instruction for the pump; convert the second data to the first format; and provide the converted second data to the pump. The first format may be the CAN-BUS or the MOD-BUS protocol. The second format may be the XBEEE, Wi-Fi, or similar format.

In an embodiment, a method for interfacing multiples devices with a platform using a gateway is provided. The method includes: receiving first data from a local interface of a first pump by a gateway, wherein the first data is in a first format; receiving second data from a local interface of a second pump by the gateway, wherein the second data is in a second format; converting the first data into a third format associated with a platform by the gateway; converting the second data into the third format associated with the platform by the gateway; and providing converted first and second data to the platform by the gateway.

Embodiments may include some or all of the following features. The method may further include presenting the converted first and second data to a user by the platform. The method may further include presenting data received from one or more other devices along with the converted first and second data to the user by the platform. The first format may be the CAN-BUS or the MOD-BUS protocol. The third format may be the XBEE, Wi-Fi, or similar format. Converting the first data into the third format associated with the platform by the gateway device may include retrieving a script associated with the first pump and converting the first data into the third format using the script.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for operating a gateway;

FIG. 2 is an operational flow of an implementation of a method for providing data received from a pump to a platform by a gateway and for controlling the pump by the gateway;

FIG. 3 is an operational flow of an implementation of a method for providing data received from multiple devices to a platform by a gateway;

FIG. 4 shows an exemplary computing environment in which example embodiments and aspects may be implemented.

### DETAILED DESCRIPTION

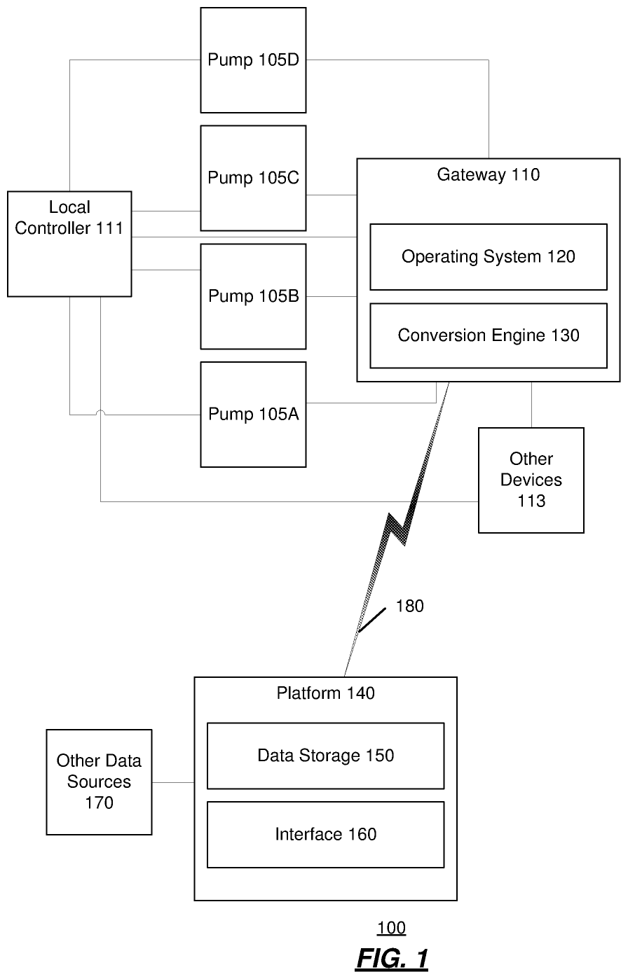

FIG. 1 is an illustration of an environment 100 for operating a gateway 110. The gateway 110 may receive data from a plurality of pumps 105 (i.e., the pumps 105A, 105B, 105C, and 105D). More or fewer pumps 105 may be supported. Each pump 105 may pump a liquid such as water. Other liquids may be supported.

Each pump 105 may be located at a user location such as a water treatment or chemical plant. Other locations may be supported. Each pump 105 may be associated with a same or different manufacturer and may output data in a format or protocol that may vary based on the manufacturer and/or model of the pump 105. Examples of formats or protocols that may be used by a pump 105 include CAN-BUS, Profi-BUS, and Mod-BUS. Other formats or protocols may be supported. The gateway 110 may further receive data from other devices 113 at the user location.

As described above, one drawback associated with pumps 105 (and the other devices 113), is that they do not include interfaces that can be remotely accessed to read data and other values associated with the pump 105. The data output by a pump 105 may include, but is not limited to flow rate, whether or not the pump is on, measured pressure, total operating time, whether or not there is a leak, flow rate, and tank level alarm. Other types of data may be supported.

Generally, the pumps 105 (and other devices 113) may be connected to a local controller 111. The local controller 111 may receive data from the pumps 105 and may provide commands to the pumps 105. However, like the pumps 105, the local controller 111 may not be able to be remotely accessed.

In order to solve the problems associated with pumps 105 and local controllers 111 noted above, the environment 100 may include the gateway 110. The gateway 110 may interface with each of the pumps 105 (and other devices 113) using a variety of technologies. The gateway 110 may interface with each pump 105 using a local interface exposed by the pumps 105. For example, the gateway 110 may interface with a pump 105 using a wired connection such as USB, ethernet, or parallel port. Wireless connections such as Wi-Fi, Zigbee Radio, or Bluetooth may be used. The particular technology used to interface with a pump 105 may depend on the particular technologies supported by the individual pump 105 and the selection of gateway 110.

The gateway 110 may further interface with a platform 140 through a network 180. The platform 140 may be cloud based and may be used by the end user or administrator to view data received from one or more other data sources 170. The other data sources 170 may be associated with the user location (i.e., the same location or facility as the pumps 105) and may include a variety of devices such as instruments, monitors, controllers, sensors, actuators etc., for the monitoring and control of process treatment systems such as chemical dosing systems. The described systems and methods for communication ensures data above and beyond base data such as pH or conductivity can be obtained to integrate data for service and analytics, such as temperature, calibration, time left to service etc. The other data sources 170 may further include devices configured to add various chemicals and/or chemistries such as chlorine, salt, fluoride, etc., and complete systems such as manual data and plant derived data. The other data sources 170 may be configured to interface with the platform 140 directly. That is, unlike the pumps 105 and the other devices 113, the other data sources 170 may communicate and provide data directly to the platform 140 in a format or protocol that is supported by the platform 140. A suitable format or protocol includes XBEE —transmitting data over various wired and wireless methods such as ZeeBee Radio, WIFI, Bluetooth and Industrial Ethernet. The platform 140 may further accept data from multiple sources such as manual inputs and plant data via cloud API or emailed CSV files.

The platform 140 may include a data storage 150 and an interface 160. The platform 140 may store data received from the other data sources 170 and/or pumps 150 for later analysis and processing in the data storage 150. Any type of storage may be used.

The interface 160 may allow a user or administrator to view the stored data received from the various pumps 105, other devices 113, and other data sources 170. In addition, the interface 160 may allow the user to control the operation of one or more of the pumps 105. A suitable platform 140 includes the InSight™ platform. Other platforms may be supported.

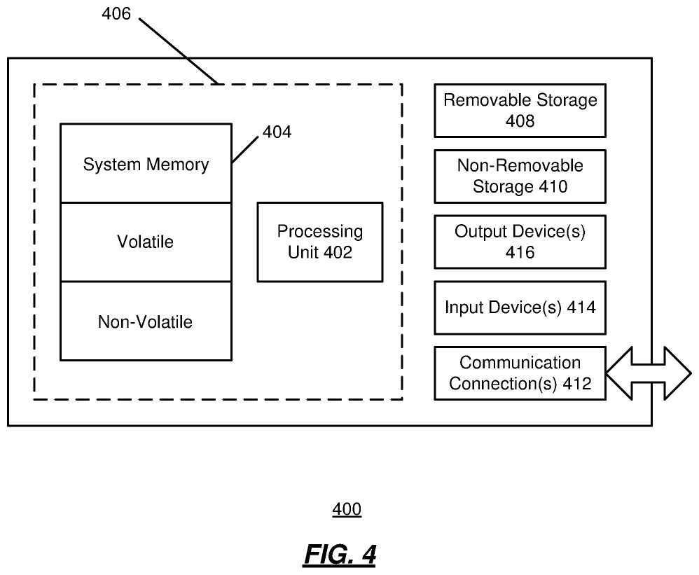

To allow a user or administrator to communicate with the pumps 105 using the gateway 110, the gateway 110 may include an operating system 120 and a conversion engine 130. The gateway 110 may be implemented using a general-purpose computing device such as the computing device 400 illustrated with respect to FIG. 4.

The operating system 120 may control the general operation of the gateway 110 including interfacing with the pumps 105 and communicating with the platform 140 via the network 180. Depending on the embodiment, the operating system 120 may communicate with the network 180 through a wired or wireless connection to the Internet. A suitable communication means includes a cellular communication means or component integrated into the gateway 110, for example.

The conversion engine 130 may receive output data from one or more pumps 105. The data received from a pump 105 may be in a format or protocol that is specific to the particular pump 105 or manufacturer of the pump 105. In one embodiment, the data received from the pump 105 may be in the CAN-BUS or MOD-BUS protocol. Other formats and/or protocols may be used.

The conversion engine 130, after receiving data from a particular pump 105, may retrieve a script that is specific to the pump 105 and/or a manufacturer of the pump 105. In some embodiments, a programmer may create a script for each pump 105 and/or pump manufacturer that takes the various fields and data types used by the pump 105 and/or manufacturer in their preferred format or protocol, and converts them into the format or protocol used by the platform 140. In some embodiments, each script may be a python script. Other types of scripting and/or programing languages may be used.

The conversion engine 130 may convert the data received from the pump 105 into the format or protocol that is expected by the platform 140 using the retrieved script. For example, the conversion engine 130 may convert the data into the XBEE format used by the platform 140. Other formats may be used.

The conversion engine 130 may transmit the converted data to the platform 140 via the network 180. The platform 140 may store the converted data in the data storage 150. A user or administrator may then later use the interface 160 of the platform 140 to view the converted data along any other data received from the other data sources 170.

In some embodiments, the interface 160 of the platform 140 may allow the user or administrator to generate commands or instructions for some or all of the pumps 105. The commands may include commands to turn of individual pumps 105, and to increase or decrease the flow rate of the individual pumps 105. Other commands may be supported.

Once a command is generated, the platform 140 may send the command to the gateway 110 using the network 180. Depending on the embodiment, the command may be in the format or protocol used by the platform 140 (e.g., wireless radio) and may be first converted to a format or protocol supported by the pump 105 that is the target of the command. Accordingly, the conversion engine 130 may retrieve a script associated with the pump 105 and may use the script to convert the command into a format or protocol that is used by the pump 105. The script may be the same script or a different script than the script that was used to convert the data from the pump 105 into data that can be used by the platform 140.

After the command is converted, the gateway 110 may provide the converted command to the pump 105 that is the target of the command. The pump 105 may then execute the command as if it had been provided to the pump 105 by a local user or administrator.

In some embodiments, rather than have the gateway 110 convert the data that is exchanged between the pumps 105 and the platform 140, the platform 140 may convert the data. That is, the conversion engine 130 may be located on the platform 140, rather than the gateway 110. In such embodiments, the gateway 110 may transmit the data as it is received from the pumps 105, and the conversion engine 130 on the platform 140 may convert the data into a format or protocol that is used by the platform 140. Similarly, the conversion engine 130 of the platform 140 may convert any commands provided by the interface 160 before the commands are transmitted to the one or more pumps 105.

In some embodiments, the gateway 110 may also communicate with and control the pumps 105 via the local controller 111. For example, the gateway 110 may read data output by the local controller 111 about the operation of the pumps 105 (and other devices 113) and may provide the data to the platform 140.

Note that while the embodiments are described as applying to pumps 105, the gateway 110 may be used with a variety of devices other than pumps 105 (e.g., the other devices 113). Example devices include analyzers, monitors, and sensors. Any device capable of exporting data (or receiving data) via one or more local interfaces may be supported. As may be appreciated, regardless of the format or protocol that is used by a device, a script can be created that coverts the format or protocol to the format or protocol used by the platform 140.

The following are multiple example scenarios where the gateway 110 described here can be used to provide advantages over the prior art.

Mass Balance/Applied Chemistry-System operational data can be improved and monitored remotely via the connection of devices 113. Example operational data that can be measured/calculated include mass balance, consumption rates, operational modes, power fluctuations and operator engagement with local devices.

A real-world application of this approach could be the use of biocide on a tunnel pasteurizer system. These systems can be subject to sudden contamination of biologics due to a packaging failure inside the pasteurizer leading to a very high demand of biocide to maintain control which by the monitoring of reserves alone will not be detected. By incorporating pump 105 data into the platform 140, it is easy to determine the increase in pump product and increase in consumption of product allowing early alarming of packaging fails in the pasteurizer. This can lead to reduced system downtime and ‘boil outs’ via early intervention to manage via flushing and online maintenance.

Stock Control—Many applications are unable to have chemical storage installations automatically monitored for current stock reserves due to the use of temporary storage or accessibility for sensor installation. Instead, the output of one or more pumps 105 can be monitored using the gateway 110, which can be used to estimate when a particular chemical stock may be running low.

Chemical Addition Verification—Many chemicals are not directly detectable via sensors or other means either due to the application removing them (RO Chemistry) or lack of commercially available analyzers (non-Ox Biocides). This makes compliance reporting and maintenance of stock onerous. By incorporating volume data from the pumps 105 along with other data showing when a chemistry was applied by another device, the application of the chemistry may be automatically logged and reported by the platform 140 complete with a time stamp detailing the specific volume applied. Alerts and notifications about chemical storage levels may also be generated by the platform 140 to ensure replenishment of stock is maintained. This high value data can be verified for legislative visits and correlation to any out of specification events such as biological build up to determine the effectiveness of both the chemistry and dosing methods. Optimization of difficult to detect chemistry can significantly improve asset performance and uptime while reducing investigative time for “out of specification” events.

System Performance Warning—By using the data provided by each pump 105, the platform 140 may generate and provide analytics of pump performance that can lead to early and fast identification of potential dosing interruptions. Proactive detection and alerting of pump 105 conditions such as of low back pressure, air bubbles, discharge valve leaks, and service requirements allows a site team to ensure dosing is maintained for compliance and asset protection. The proactive detection and alerting may ensure the alerts are deployed in a matter of minutes should a local issue arise. By combining notification on pump 105 output pressure and residuals in the process, early indication of dosing hose failure can be determined and acted upon to minimize any health, safety or environmental impact protecting not only business reputation but avoiding the risk of enforcement, remediation works or wasted cost through loss of chemical product.

Reduced Performance Identification—As chemistry formulations develop and application approaches change there is a need to ensure pump 105 settings are correctly adjusted and maintained to ensure chemical performance. Additionally, it is important that when personnel are attending to a chemical dosing system for maintenance or other activities it is returned to its correct level of automated control. Accordingly, the gateway 110 may report (to the platform 140) when a pump 105 has been placed in automatic, service, or manual mode. The gateway 110 may further report manual and automated set point changes to show what adjustment have been applied to maintain performance. Based on this information, the platform 140 may determine what pump 105 settings need adjustment or where human intervention has resulted in a variation of performance of a pump 105. A common example of this is where pumps 105 are placed in manual control during plant servicing or outage and not returned to full automated control upon restart leading to under or overdosing scenarios. With the connected pump 105 it is possible to identify this route cause and correct it at speed. Additionally, where pumps 105 should be operated automatically it is possible to set via the platform 140 an automated alarm to notify the team of a pump 105 in an alternative setting.

Syphoning—Chemical addition should always be applied by the operation of a pump 105, however in some circumstance's installations are not performing as expected due to product syphoning past the dosing pump head and into the process application, leading to unexpected outcomes. By using data from a tank level sensor connected to the platform 140 and a dosing pump 105 connected to the gateway 110, the platform 140 may determine when product is being applied to a process while a pump 105 is “resting” or how more product is applied than the actual pump speed/output is set for. Syphoning events can have a disastrous effect on a system and are usually the result of a component failure and often go undetected for significant periods of time. Detection of chemical loss in this way is a substantial advantage when operating systems to ensure full asset protection is achieved. Particularly on aggressive chemicals like sulphuric acid which can do high value damage to system metallurgy if applied in an uncontrolled manner.

Remote Support—By reviewing plant data remotely using the gateway 110, a user and administrator may support on site technicians in trouble shooting and provide advice on both short and longer-term solutions to ensure reliability. Avoiding the cost of emergency call out or duplicate site visits is just one of the many advantages of the gateway 110. Additionally, arriving with the correct parts and equipment to rectify the faults after remote diagnostics provided by the gateway 110 reduces the overall time/cost of the fault rectification. It is often a case where personnel are called to a “lack of dosing/broken pump” to find that the pump 105 is not at fault and is working correctly. By remotely seeing if the pump 105 is being called to operate and its reaction using the gateway 110, technicians can come prepared to investigate the issue.

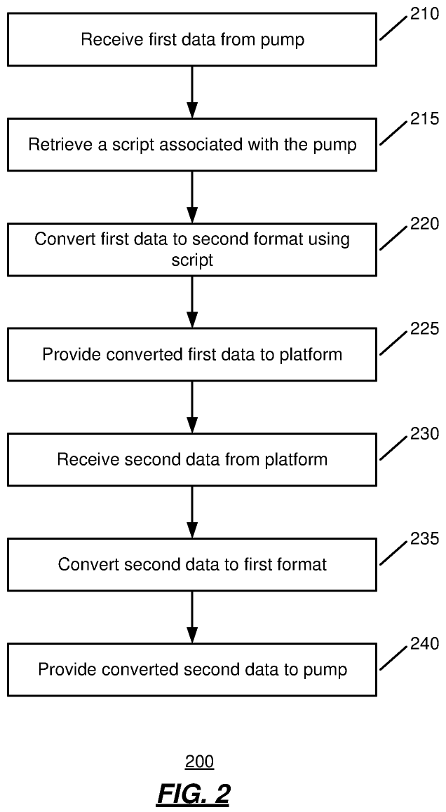

FIG. 2 is an illustration of a method 200 for operating a pump 105 or other device connected to a gateway 110. The method 200 may be performed by a gateway 110 and/or may be implemented using a cloud-based computing environment.

At 210, first data from a pump is received. The first data may be in a first format or protocol used by the pump 105. The first data may include operating and status data generated by the pump 105. The first data may be received by the gateway 110 from a wireless or wired interface or connection between the pump 105 and the gateway 110.

At 215, a script associated with the pump is retrieved. The script may be retrieved by the gateway 110. The script may be stored in a memory of the gateway 110 or may be requested and downloaded by the gateway 110 from a third-party or manufacturer of the pump 105. The script may be a python script that is able to convert the first format or protocol used by the pump 105 into a second format or protocol that is used by a platform 140.

At 220, the first data is converted from the first format into the second format using the script. The first data may be converted by the gateway 110 executing the script with the received first data as an input.

At 225, the converted first data is provided. The converted first data may be provided by the gateway 110 to the platform 140. Depending on the embodiment, the converted data may be provided via a network 180 such as a cellular connection between the gateway and the platform 140. Other types of networks may be supported. The received converted data may be stored by the platform 140 and/or displayed to one or more user or administrators in an interface provided by the platform 140. The converted data may be displayed along with data received from other sensors or devices (e.g., other devices 113) at or around a location associated with the pump 105.

At 230, second data is received. The second data may be received by the gateway 110 from the platform 140. The second data may be an instruction or command for the pump 105. For example, the command may be to reduce or increase a pumping rate of the pump 105. The second data may be in the format or protocol used by the platform 140.

At 235, the second data is converted into the first format. The second data may be converted by the gateway 110. Depending on the embodiment, the gateway 110 may convert the second data using the same script, or a different script, than the script that was used to convert the first data.

At 240, the converted second data is provided to the pump. The converted second data (i.e., the command) may be provided to the pump 105 through the interface or connection between the gateway 110 and the pump 105. The pump 105 may then execute the command included in the converted second data.

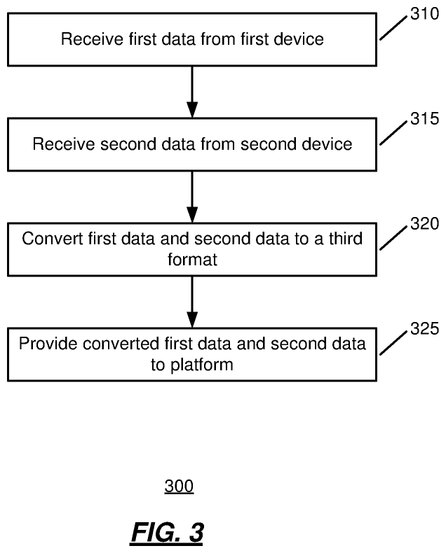

FIG. 3 is an illustration of a method 300 for using a gateway connected to a plurality of devices. The method 300 may be performed by the gateway 110.

At 310, first data is received from a first device. The first data may be received by the gateway 110 from the first device. The first device may be a pump, a sensor, an analyzer, or any other type of device that may be used in a facility or location. The first data may be in a format that is specific to the first device or a manufacturer of the first device. The first data may be received via a wireless or wired connection or interface between the gateway 110 and the first device.

At 315, second data is received from a second device. The second data may be received by the gateway 110 from the second device. The second device may a different type of device or from a different manufacturer than the first device. The second data may be in a format that is different than the format used by the first device. The second data may be received via a wireless or wired connection or interface between the gateway 110 and the second device. The first device, the second device, and the gateway 110 may be associated with the same location, operation, or entity. For example, the devices and gateways may be located in the same water treatment plant.

At 320, the first data and the second data are converted to a third format. The first data and the second data may be converted to the third format by the platform 140. The platform 140 may convert the first data to the third format using a script associated with the first device, or a manufacturer of the first device, and may convert the second data to the third format using a script associated with the second device, or a manufacturer of the second device. The third format may be a format used by the platform 140.

At 325, the converted first data and second data are provided. The converted first data and second data may be provided by the gateway 110 to the platform 140. The platform 140 may then store the data and may display the data along with data received from other sensors or devices associated with the location to a user or administrator.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 5 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for interfacing multiples devices with a platform using a gateway comprising:
receiving first data from a first device by a gateway, wherein the first data is in a first format;
receiving second data from a second device by the gateway, wherein the second data is in a second format;
converting the first data into a third format associated with a platform by the gateway;
converting the second data into the third format associated with the platform by the gateway; and
providing converted first and second data to the platform by the gateway.

2. The method of claim 1, further comprising presenting the converted first and second data to a user by the platform.

3. The method of claim 1, further comprising presenting data received from one or more other devices along with the converted first and second data to the user by the platform.

4. The method of claim 1, wherein the first device is a pump.

5. The method of claim 1, wherein the first format is the CAN-BUS protocol.

6. The method of claim 1, wherein the first format is the MOD-BUS protocol.

7. The method of claim 1, wherein the third format is the XBEEE or Wi-Fi format.

8. The method of claim 1, wherein converting the first data into the third format associated with the platform by the gateway device comprises retrieving a script associated with the first device and converting the first data into the third format using the script.

9. A gateway for interfacing multiple devices with a platform comprising:
at least one computing device; and
a memory storing computer-executable instructions that when executed by the at least one computing device cause the at least one computing device to:
receive first data from a location interface of a pump, wherein the first data is in a first format and the first data describes operating characteristics of the pump;
retrieve a script associated with the pump;
convert the first data into a second format using the script; and
provide the converted second data to a platform.

10. The gateway of claim 9, further comprising computer-executable instructions that when executed by the at least one computing device cause the at least one computing device to:
receive second data from a plurality of devices; and
display at least some of the first data and the second data in a graphic user interface.

11. The gateway of claim 9, further comprising computer-executable instructions that when executed by the at least one computing device cause the at least one computing device to:
receive second data from the platform, wherein the second data is in the second format, wherein the second data is an instruction for the pump;
convert the second data to the first format; and
provide the converted second data to the pump.

12. The gateway of claim 9, wherein the first format is the CAN-BUS protocol or the MOD-BUS protocol.

13. The gateway of claim 9, wherein the second format is the XBEEE or Wi-Fi format.

14. A method for interfacing multiples devices with a platform using a gateway comprising:
receiving first data from a local interface of a first pump by a gateway, wherein the first data is in a first format;
receiving second data from a local interface of a second pump by the gateway, wherein the second data is in a second format;
converting the first data into a third format associated with a platform by the gateway;
converting the second data into the third format associated with the platform by the gateway; and
providing converted first and second data to the platform by the gateway.

15. The method of claim 14, further comprising presenting the converted first and second data to a user by the platform.

16. The method of claim 15, further comprising presenting data received from one or more other devices along with the converted first and second data to the user by the platform.

17. The method of claim 14, wherein the first format is the CAN-BUS protocol.

18. The method of claim 14, wherein the first format is the MOD-BUS protocol.

19. The method of claim 14, wherein the third format is the XBEE or Wi-Fi format.

20. The method of claim 14, wherein converting the first data into the third format associated with the platform by the gateway device comprises retrieving a script associated with the first pump and converting the first data into the third format using the script.
